(19) United States
(12) Patent Application Publication
(10) Pub. No.: US 2009/0186631 A1
(43) Pub. Date: Jul. 23, 2009

(54) Location Based Information Related to Preferences

(76) Inventor: Fred E. Masarie, JR., Portland, OR (US)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/018,003

(22) Filed: Jan. 22, 2008

(51) Int. Cl. H04Q 7/20

(52) U.S. Cl. 455/456.3

(57) ABSTRACT

A system, method, and apparatus for providing location based information related to user preferences is disclosed. One embodiment comprises first storing in a memory a first data set that includes information related to at least one geographic location, and the information is hierarchically organized by content according to an indexing scheme, and specifying a second data set that includes user preferences, wherein the user preferences are hierarchically organized by content according to the indexing scheme. Then, by knowing or determining a specific geographic location using a location determining device, an embodiment can generate one or more interests for the specific geographic location, according to information common to the first data set and the second data set, or information related to the first data set and second data set by the indexing scheme. Additionally, some embodiments may provide a list of locations that have information or content matching user specified interests.

### BACKGROUND

Recent technological developments have generated very precise methods for determining a location. For example, the Global Positioning System (GPS) incorporates a constellation of satellites that simultaneously transmit signals with precise timing (and other) information to a GPS receiver, allowing the GPS receiver to determine its current time, location, speed, and direction based on time differences between the transmitted signals. Other similar satellite systems include the Russian GLONASS system, the Chinese COMPASS navigation system, and the European Galileo positioning system, as examples. Other location based services may also be used, for example, a mobile positioning system may use signals from one or more cellular towers (base stations), to accurately determine a current location.

Additional functionality may be used in conjunction with location enabled devices or location based services. For example, a GPS enabled device may coordinate mapping features with the location, speed, direction and time information derived by a GPS receiver, and may further provide the coordinated information through a user interface. In one particular example, a dashboard GPS device with mapping functionality may provide a user with not only raw location, speed, etc. information, but it may also provide a graphical representation including a map that shows the location of the GPS device in a more readily understood format. GPS devices may comprise similar functionality but in a separate form factor, such as in navigation devices in general, mounted units, hand held units, cellular telephones with GPS functionality, personal digital assistants (PDA) with GPS functionality, or other suitable devices that may receive GPS signals directly, or input signals from a GPS device, and coordinate the resulting location, speed, altitude, etc. information with a mapping feature.

Further, even more functionality may be utilized in conjunction with location based service and mapping features. For example, a database or data records may be accessed to provide directions to a location or between two locations, information about businesses at specific locations, dynamic information such as current traffic and weather, etc., when used in conjunction with the mapping features, thus providing a user with more detailed information about specific locations.

Many databases exist today that contain information about geographic locations, such information may be longitude and latitude, but also may include elevation, addresses, phone numbers, and limited information regarding what is at the location, for example, a post office, a French restaurant, or a museum, etc. Unfortunately, current approaches provide information that is bound to geographic locations in bulk, and they often provide more information than a user desires. Additionally, the information that one user may be interested in might be different from the information another user may be interested in.

Additionally, information about a geographic location may not be available at the location itself. For example, information about the location may be found on the Internet, in a newspaper, in a travel book, or through interpersonal communications, but at the location there may be limited or no access to the original information. Further, information may often have a temporal component to it, such as information about a folk festival on a certain date, a year-end clearance sale that is currently happening, or a state park that is only open from April-November.

### SUMMARY

Accordingly, various embodiments for a system, method or apparatus provide location based information related to user preferences as described below in the Detailed Description. For example, one embodiment comprises a method that stores information related to a geographic location in a first data set, wherein the information is hierarchically organized by content according to an indexing scheme. Then, the method specifies a second data set including user preferences, wherein the user preferences are also hierarchically organized by content according to the indexing scheme. Finally, a set of interests for a specific geographic location can be determined using the first data set including geographic location information or the second data set including user preferences, wherein the interests may be common to both data sets, or related by the indexing scheme.

In another example, an embodiment may comprise a database of geographic locations, a database of information/content with time-awareness, a controlled terminology for indexing content, and a user profile with indicated preferences using the same controlled terminology.

This Summary is provided to introduce concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a block diagram of one embodiment with a GPS receiver as a location determining device.

FIG. 2 shows a process flow depicting an embodiment of a method for providing location based information related to user preferences.

FIG. 3 illustrates a data-diagram according to the present disclosure.

FIG. 4 illustrates a screen shot depicting a main navigation page of an embodiment according to embodiments described in the present disclosure.

FIG. 5 illustrates a screen shot depicting a page to manage a taxonomy of interests according to embodiments described in the present disclosure.

FIG. 6 illustrates a screen shot depicting a page for managing enhanced searching aspects according to embodiments described in the present disclosure.

FIG. 7 illustrates a screen shot depicting a page for managing content according to embodiments described in the present disclosure.

FIG. 8 illustrates a screen shot depicting a page for managing content and interests according to embodiments described in the present disclosure.

FIG. 9 illustrates a screen shot depicting a page for managing a user location according to embodiments described in the present disclosure.

FIG. 10 illustrates a screen shot depicting a page for managing locations for content according to embodiments described in the present disclosure.

FIG. 11 illustrates a hierarchy of interests for providing location based information related to user preferences according to embodiments of the present disclosure.

### DETAILED DESCRIPTION

Generally, this detailed description describes approaches to provide personalized information according to preferences and location. As more location based information is stored electronically, the need increases for an intelligent matching of user interests to the information. Additionally, as location based services are incorporated into more devices, it would be advantageous to specify interests a limited number of times and compare location based information to the preferences automatically, instead of having to review and sort a large amount of information for each location a user is interested in, when the information is not available, etc. The following detailed description provides example embodiments to illustrate a system, method and apparatus to provide these and other advantages, but these examples are not intended to limit the invention as described in the appended claims, and their equivalents.

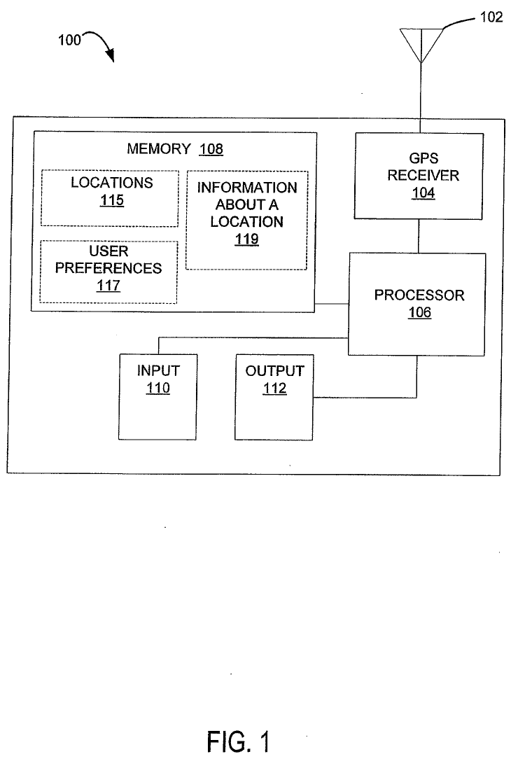

Referring now to FIG. 1, an embodiment mobile device 100 is described. In some embodiments, Mobile device 100 includes a processor 106, a memory 108 coupled with processor 106, an input 110 and an output 112 both coupled with processor 106, and also an antenna 102 and GPS receiver 104. Input 110 may be through a keypad, keyboard, touch-screen, buttons, a mouse, voice recognition, image recognition, a network connection, from a file storing information, etc.

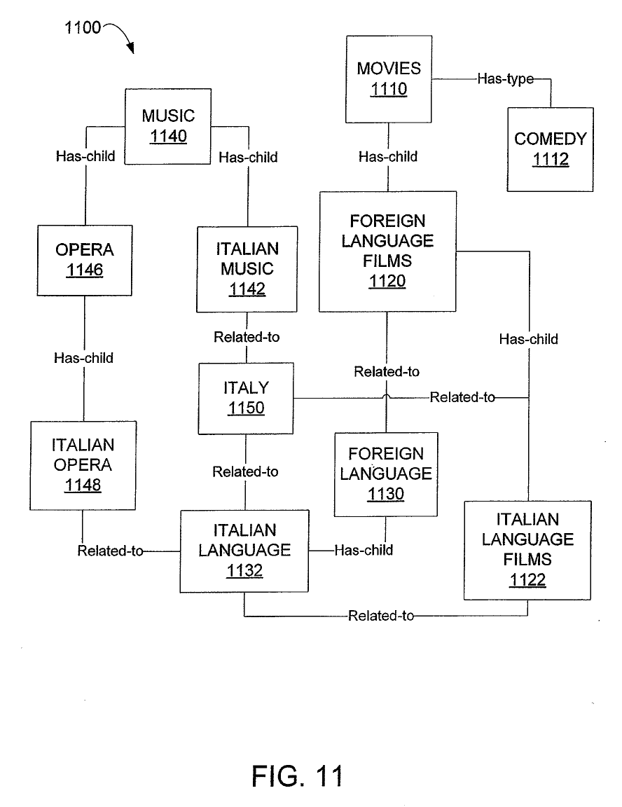

Additionally, memory 108 may include information related to one or more locations 115, to user preferences 117, and to content/information about the location(s) 119. In some embodiments, memories may comprise other classes of information related to the present detailed description than those described in reference to FIG. 1. In this manner, memory 108 stores a first data set that includes information related to at least one geographic location 119, and memory 108 further includes a second data set that includes user preferences 117, wherein the information 119 and the user preferences 117 are hierarchically organized by content according to an indexing scheme, as described with reference to FIG. 11.

In this way, the indexing scheme may use the same hierarchical structure for both the user preferences 117 and the information 119. For example, the hierarchical structure may be organized in a taxonomy of interests (preferences), whereby users can specify an interest at a higher level, e.g., listening to live music, and the indexing scheme can correlate related events such as a symphony, folk music festivals, and free jazz concerts at a local park, etc. In this way, content can be provided that matches directly with terms used to describe preferences, as content related to the preferences, in sub-classes or generalized classes of the preferences, or otherwise as content that is related to the preferences in a non-hierarchical fashion, as described below in reference to FIG. 11.

Continuing with the embodiment illustrated in FIG. 1, mobile device 100 may include an antenna 102 to receive GPS signals and send the signals to GPS receiver 104, where GPS receiver 104 uses the signals to determine the specific geographic location of the mobile device. In this way, the processor 106 may use the specific geographic location from GPS receiver 104 along with information in the memory 108 to generate a set of interests for the specific geographic location.

In the present example, a GPS receiver 104 and GPS signals are described, but other embodiments are not so limited, and may utilize any suitable signal that allows resolution of a location based on the signal, such as a cellular signal, broadcast radio signals, other satellite signals, etc.

In some embodiments, mobile device 100 may generate a set of interests that is based on information common to the first data set comprising information about a location 119 and the second data set comprising user preferences 117. In some embodiments, the set of interests may include time-based information related to at least one of the geographic locations. Additionally, mobile device 100 may use a hierarchical indexing scheme to generate the set of interests based on information about a location 119 that is hierarchically related to the user preferences 117.

Furthermore, mobile device 100 may have an output 112 coupled with the processor 106, wherein the output 112 may provide the set of interests to a user interface, such as a graphical user interface, an audio user interface, through a website, etc. In some embodiments, output 112 may provide the set of interests in a form such as a file that may be sent to or stored on other devices, for example to print a user-specific travel guide focused on the set of interests as described herein. In some embodiments, the user interface may provide content that is based on user preferences 117 in the form of a personal radio station, personalized advertisements, public service announcements, information about the current location of the mobile device 100, music based on the user preferences 117, or any other content that is related to the user preferences 117.

In other embodiments, the set of interests may be created on a non-location based device, stored in a file, and downloaded to a location based device, whereby the relevant information may be displayed according to a detected location. In some embodiments, the displayed information may have been pre-selected according to the user preferences 117. In some embodiments, the set of interests may be delivered over a non-GPS enabled cell phone using voice recognition software, whereby a user may verbally provide a location and in turn be provided with relevant location based information based on previously specified user preferences.

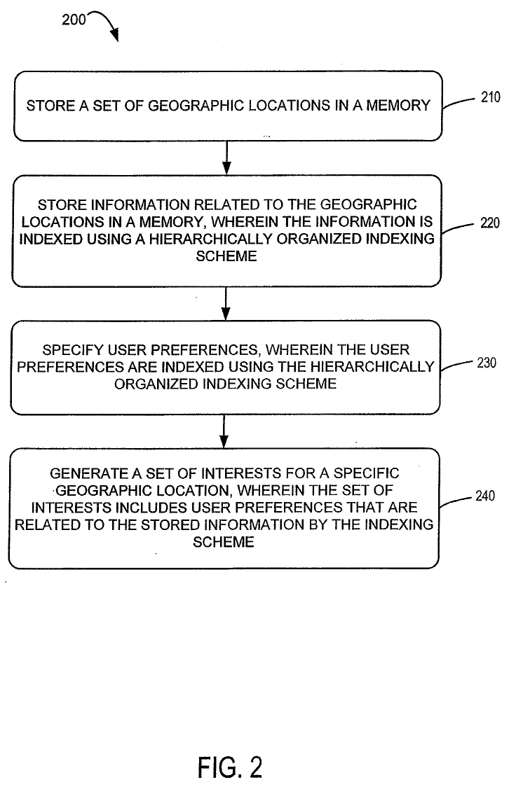

In reference to FIG. 2, a flow chart illustrates an example method 200 for providing location based information related to user preferences. Method 200 may be a process for providing the functionality of mobile device 100, but it is not so limited and may contain other features or variations as described within the present disclosure. In block 210, method 200 comprises storing a first data set of geographic locations in a memory. In other embodiments, a method may alternately access the first data set on a storage medium, or receive the first data set over a connection, as examples.

Then, method 200 comprises storing a second data set in the memory, wherein the second data set includes information related to at least one of the geographic locations, and the information is hierarchically organized by content according to an indexing scheme, as indicated in block 220. Such hierarchical organization and indexing scheme are described in more detail with reference to FIG. 11 below. Similar to the first data set of geographic locations, in other embodiments, a method may alternately access the second data set on a storage medium, or receive the second data set over a connection, as examples.

Next, method 200 comprises specifying a set of user preferences, wherein the set of user preferences is hierarchically organized by content according to the indexing scheme, as indicated at 230. Therefore, the indexing scheme may use the same hierarchical structure for both information related to a geographic location as in step 220 and also to the user preferences in block 230.

In other embodiments, the hierarchical organization and indexing scheme may be used with other information, such as the first data set of geographic locations in a memory in block 210, or even other information that may be advantageously organized in a similar scheme. For example, the hierarchical structure may be organized in a taxonomy of interests (preferences) as explained above in the music example with reference to mobile device 100. In this way, content can be provided that matches directly with terms used to describe preferences, as content related to the preferences, in sub-classes or generalized classes of the preferences, or otherwise as content that is related to the preferences in a non-hierarchical fashion, as described below in reference to FIG. 11.

In block 240, method 200 comprises generating a set of interests for a specific geographic location, wherein the set of interests includes user preferences that are related to the stored information by the indexing scheme. For example, the set of interests may include at least one of information common to the set of user preferences and the second data set, or information in the second data set related to information in the set of user preferences by the indexing scheme. In some embodiments, method 200 may further comprise determining the specific geographic location using a GPS receiver, or other signals that allow derivation of a location or signals that contain location based information.

In embodiments that comprise additional content hierarchically organized according to the same indexing scheme, the generated set of preferred information for a specific location may also include information from the additional content. For example, real-time information may be received in a streaming fashion, and if this real-time information utilizes the same indexing scheme, then method 200 may continually update the set of preferred information according to the streamed additional content, as an example. Similar to the functionality of mobile device 100, in some embodiments method 200 may further provide the generated set of interests for the specific geographic location through a user interface, such as a graphical user interface, an audio user interface, a website, etc.

Additionally, some embodiment methods may further comprise storing the set of preferred information for the specific geographic location in a file, and downloading the file to a mobile device. As a non-limiting example, some of the steps of method 200 may be run on a computing device prior to traveling to a location, and an informationally directed subset of location based information may be downloaded to a GPS enabled personal travel assistant. In this way, the personal travel assistant can generate the set of interests as described in reference to block 240 above.

It will also be appreciated that the embodiments described herein may be implemented, for example, via computer-executable instructions or code, such as programs, stored on a computer-readable storage medium and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including, but not limited to, PDAs, navigation devices, cellular telephones, GPS receivers, location enabled devices, or even other devices such as personal computers, servers, laptop computers, hand-held devices, microprocessor-based programmable consumer electronics and/or appliances, routers, gateways, hubs and other computer networking devices.

As an example, some embodiments may be a computer-readable medium comprising instructions executable by a computing device to provide location based information related to user preferences. According to these embodiments, the instructions may be executable to store a first data set in a memory, wherein the first data set includes information related to at least one geographic location, and the information is hierarchically organized by content according to an indexing scheme. Then, the instructions may specify a second data set that includes user preferences, wherein the user preferences are hierarchically organized by content according to the indexing scheme.

In this way, the medium may determine a specific geographic location using a GPS receiver, and generate a preferred information data set for the specific geographic location, wherein the preferred information data set comprises at least one of information common to the first data set and the second data set, and information in the first data set related to information in the second data set by the indexing scheme. Although this embodiment is different than the embodiment described in reference to method 200, variations of the present embodiment may include other variations as described with reference to method 200 and within this disclosure generally.

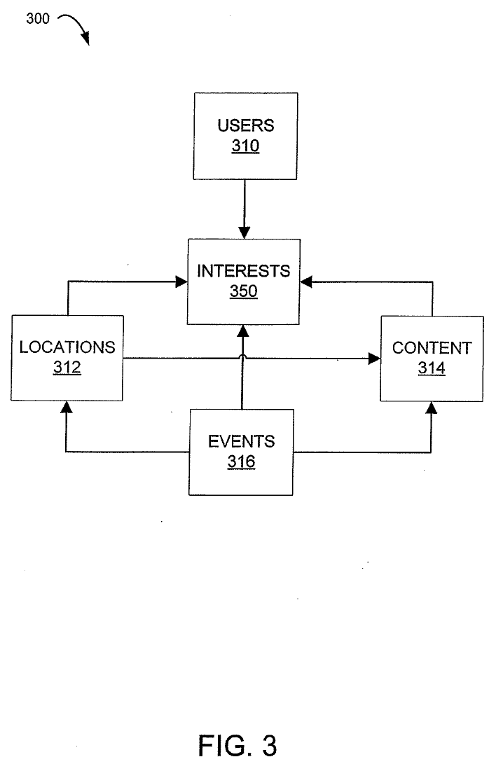

FIG. 3 illustrates a simplified data-diagram 300 according to embodiments of the present disclosure. According to the illustration, interests 350 may be associated with user preferences from one or more users 310, with content 314, with locations 312, or with events 316. Additionally, locations 312 may be associated with one or more pieces of content 314, and events 316 can be associated with one or more locations 312, with one or more pieces of content 314, etc. In this way, content can be location or event specific, and interests 350 may be specifically linked to user preferences, events, locations and content, as illustrated and as otherwise described in the present disclosure. Other data-diagrams can link different groups of information, or link the information with different relationships. Therefore, the simplified data-diagram 300 in FIG. 3 is by way of example, and is not intended to limit embodiments in the present disclosure.

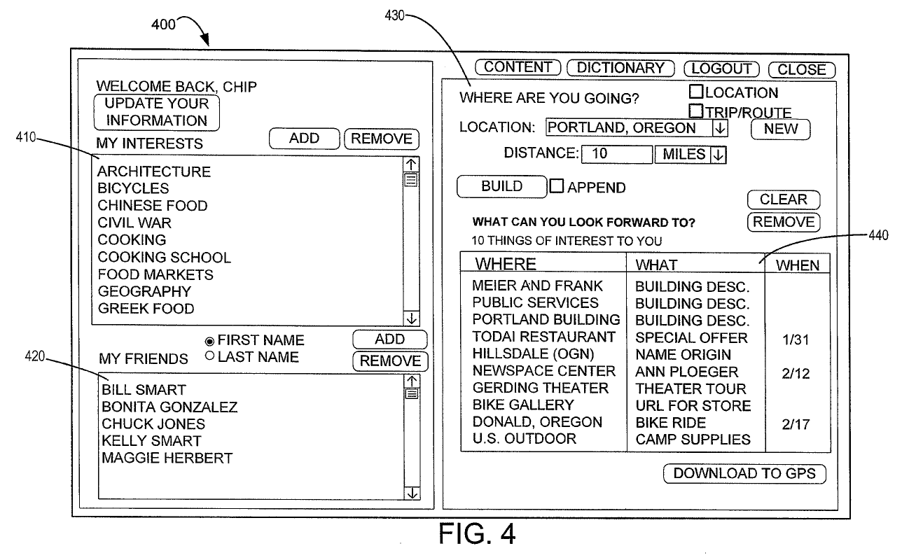

FIGS. 4-10 illustrate screen shots of an embodiment with a web page interface. These figures and the following description are intended to graphically illustrate aspects of the present disclosure, and are by way of example on non-limiting. FIG. 4 illustrates a screen shot 400 depicting a main navigation page of an embodiment according to embodiments described in the present disclosure. At 410, the screen shot 400 displays a catalog of interests, also referred to herein as user preferences. Therefore one or more users of an embodiment system will have the ability to indicate one or more items interest, also called user preferences in relation to FIG. 1 and FIG. 2. In some multi-user environments, the interests 410 can be flagged as private and only be visible to the user to whom the interests apply. Screen shot 400 includes buttons to add or remove entries in the interests 410 section, and is presented in a conventional format allowing a user to scroll through a large list of interests when the list of interests is too large to display on one screen.

Screen shot 400 also illustrates a friend list 420, whereby a user can indicate one or more friends who are also users of the system, allowing a user to share information accordingly. As an example, specifying friends allows a user to share interests as well as benefit from recommendations and reviews by trusted sources such as other users in their friends list 420. Additionally, friend list 420 includes buttons to add or remove entries from the friends list, and may further include display options, such as displaying friends according to first name, last name, etc.

Screen shot 400 may include a location entry 430, whereby a user of the system will have the ability to specify locations or routes for which they desire information matching his/her interests 410. In a GPS enabled embodiment, a location may be a geographic point specified by a longitude and latitude, but other embodiments are not so limited. Additionally, in some embodiments, a route may be a series of locations that a user wishes to travel through. Also illustrated at 430, a user may indicate how near a location or route the items of interest may be. In the illustrated example, screen shot 400 depicts that a user is searching for matches of their interests within 10 miles of a specific location.

In the illustrated embodiment, a user may then press the Build My Guide button, and generate a list for the user of items of interest 440. In the present embodiment, the items (set) of interests 440 may be based on: a specific geographic constraint such as a location, a route, etc.; on specified interests or user preferences; on a specific date or range of dates (for time-based information); and on interests that have been associated with the information by the content authors/editors. In the example in FIG. 4, the items of interest 440 are illustrated with additional categories for “where”, “what” and “when”, but other embodiments are not so limited. For example, there may be a historic bicycle ride in Donald, Oreg. on Feb. 17, 2008.

In the present example, the set of interests comprises a list, wherein each interest is associated with a geographic location such as longitude and latitude, and links to content (audio, video, web links, text, or photos) may be provided according to the interests, as well as any time based information (events or seasonal), etc. Accordingly, this information can then be downloaded to a GPS enabled device (phone, personal travel assistant, auto-based GPS, etc), or other location based devices. In some embodiments, as described above, similar functionality as that depicted in FIG. 4 may be embedded in a GPS enabled device or in other types of location based devices. Other embodiments may have different functionality than that illustrated in screen shot 400, consistent with the principles of this disclosure.

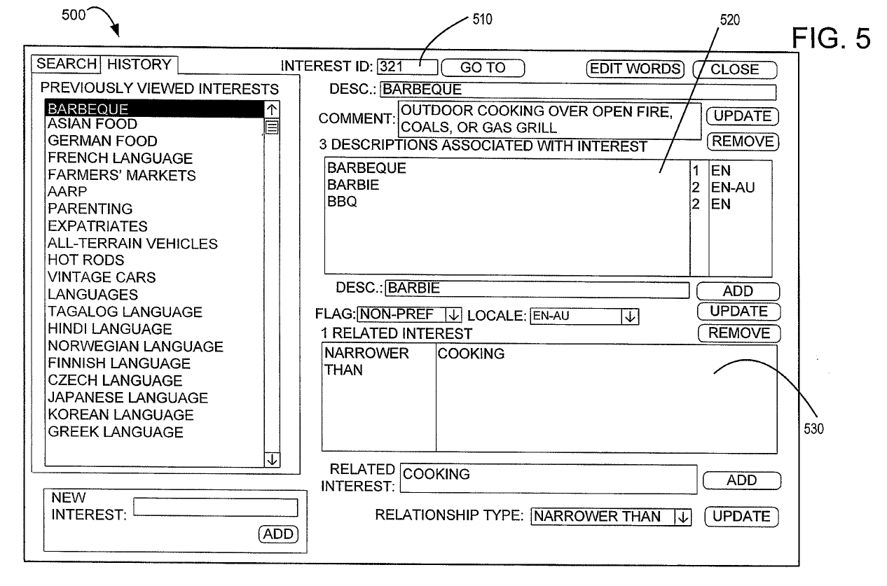

FIG. 5 illustrates a screen shot 500 depicting a page to manage interests according to embodiments described in the present disclosure. Screen shot 500 illustrates a interest identifier 510 to uniquely differentiate between multiple interests. Screen shot 500 further illustrates a description category and an optional comment category, whereby a specific interest identifier 510 may be associated with a name and with a comment providing additional information about the interest.

Screen shot 500 further depicts a list of additional descriptions 520, wherein each interest can have one or more additional associated descriptions. In some embodiments, these additional descriptions 520 may be flagged by the locale for which the description is valid. Additionally, a locale can be specified at a language level, e.g., all English language speakers, or at the language plus country level to indicate regional variations within a given language, e.g., a barbeque in the United States versus a “barbie” in the English speaking country Australia. Additionally, with reference to the additional descriptions 520, one description may be labeled as a preferred description using an interest identifier (number). In the illustrated example, the number 1 is associated with “barbeque”. Additionally, an interest identifier can be used to describe a default description for the interest, as is depicted in the description box above the comment section and below the interest ID in screen shot 500. In this same example, “barbie” and “BBQ” each have an interested identifier of 2, signifying they have a different level of preference.

With reference to dialog box 530, each interest or user preference can be related to one or more other interests, wherein the interests are arranged in a hierarchical structure. This functionality allows embodiments to provide a user with more specific interests when the user indicates an interest at a broader level.

For example, if a user is interested in eating Asian food, they may be interested in Chinese, Japanese, or Thai restaurants, as an example. By creating a hierarchy of information with a general interest for Asian food, and specific related interests for different types of Asian food, a user may be provided with a more useful set of interests, in an efficient format, and according to the relatedness of the content or interests. In the illustrated example, the description “barbecue” is coordinated with interest identifier 321, with descriptions associated with the interest including “barbie” which is associated by the English language and by Australia, further having a related interest of cooking, whereby barbeque is defined as narrow than cooking.

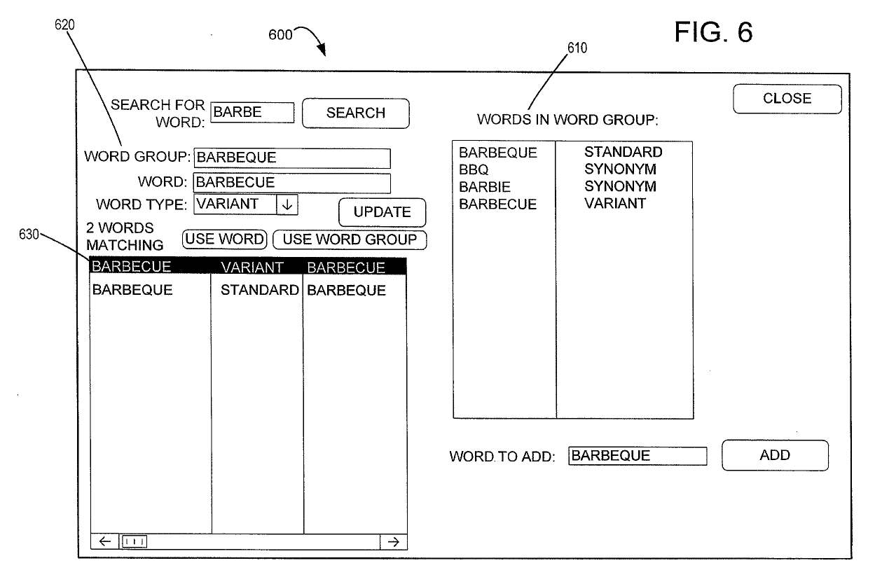

FIG. 6 illustrates a screen shot 600 depicting a page for managing enhanced searching aspects according to embodiments described in the present disclosure. Continuing with the barbeque example in screen shot 500, in addition to supporting multiple descriptions for a given interest, a word grouping 610 may be provided that allows words that mean the same thing to be grouped together.

Therefore, for example, if one of the interests is “Mongolian barbeque” and someone searches for “Mongolian barbecue”, then by grouping variations of barbeque in word grouping 610, the user may be directed to the existing interest, i.e., Mongolian barbeque. Furthermore, the word grouping facility may organize a word group according to an entry at 620, and have various relationships that may be attributed to words in a word group. For example, a list of words matching a search may be displayed at dialog box 630, wherein barbecue is within the barbeque word group and is related as a spelling variant, while BBQ and barbie are listed as synonyms. Additionally, screen shot 600 illustrates a word search tool that allows whole or partial words to be searched, and thus provides a list of words in a word grouping 610.

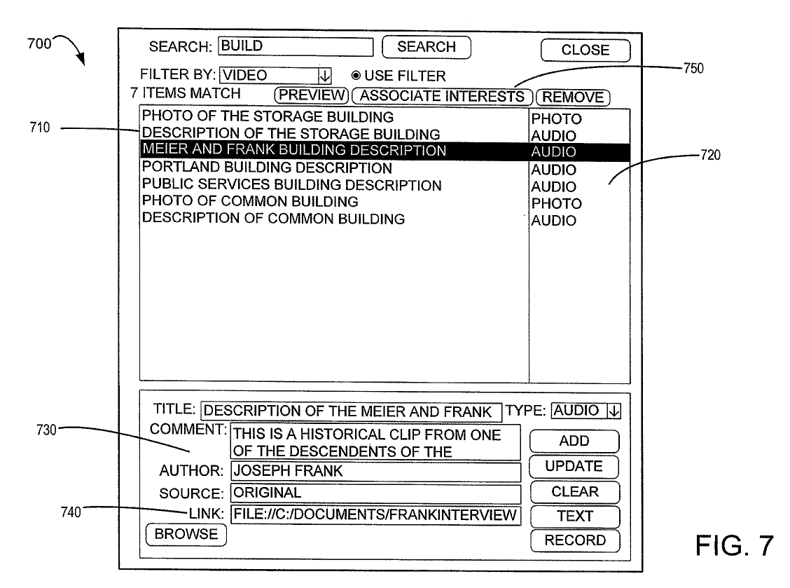

Referring now to FIG. 7, a screen shot 700 is illustrated that depicts a page for managing content 710 according to the present disclosure. In general, content 710 can be any information that is to be delivered to an end-user. Content 710 may also be associated with one or more interests. In some embodiments, content 710 may be created by authors, for example by either a specifically enumerated author, by an anonymous author, or by a combination of authors.

Additionally, content 710 may be in various types, such as: photo, audio, text, hyperlink, or video, as non-limiting examples depicted by reference numeral 720. Accordingly, at dialog box 730, details may be associated with content, wherein the author and source of the content may be identified, whether the content has a time-based component, etc. In some embodiments, time-based content may comprise events such as concerts, fairs, seasonal activities that occur every year, promotions at businesses, or the like.

Furthermore, screen shot 700 depicts a link 740, whereby the content may be linked via a URI to content residing in a database, on a file system, remotely via the internet, or over some other connection or link. Content may also be associated with one or more interests using an associate interests 750 input, in this way it can be provided to an end-user in relation to user preferences 117 of that end-user.

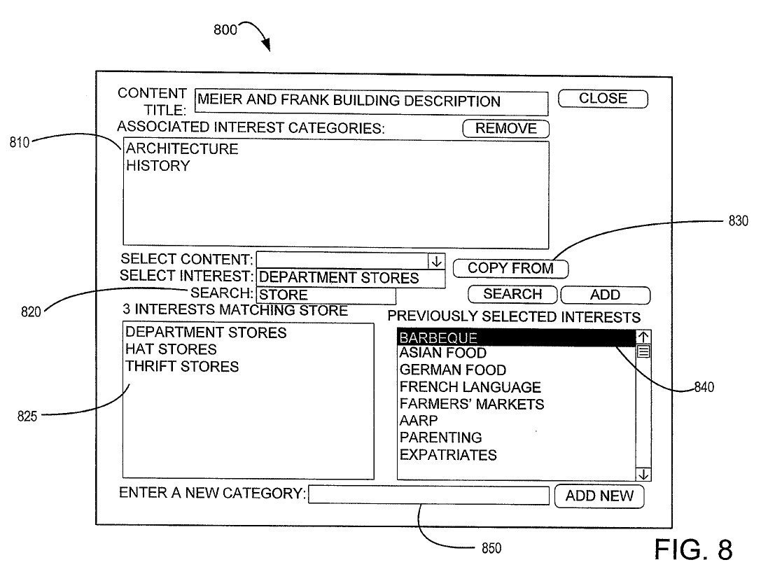

FIG. 8 illustrates a screen shot 800 depicting a page for managing content and interests according to the present disclosure. Associated interest categories 810 shows content that is associated with one or more interests form a hierarchical organization of information, or taxonomy of interests, as described herein and as associated using the associate interest 750 input in screen shot 700 described above. Additionally, interests can be identified and displayed in dialog box 825 by searching the taxonomy of interests as depicted in box 820.

In some embodiments, functionality may be provided to manage and browse content. For example, interests can be copied between different content entries using button 830. Additionally, interests can be selected from recently used interests 840. In some embodiments, if an interest is not found by searching, a new interest 850 can be specified and added to the taxonomy of interests. In some embodiments, the new interest may be reviewed to determine if it is in fact a new interest. If the interest is indeed a new interest, a user can be connected to other related interests, as described herein. On the other hand, if the interest is determined to be only a synonym of an existing interest, then the interest may be merged into the existing interest and defined as another description for that existing interest.

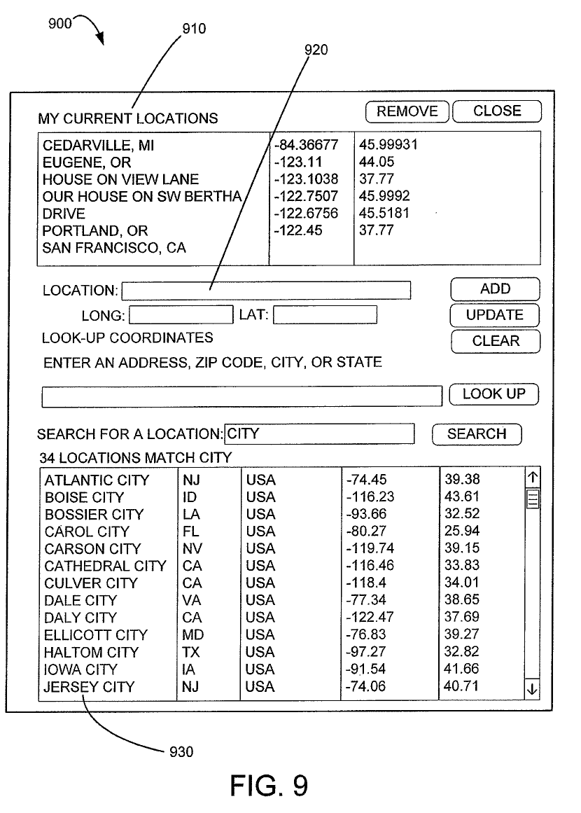

FIG. 9 illustrates a screen shot 900 depicting a page for managing a user location according to embodiments as described herein. In the illustrated embodiment, current locations 910 may comprise a list of commonly used locations, including their home, town or city, and places they frequently travel to, as non-limiting examples. Furthermore, at 920 a user location can be manually added by entering location information such as coordinates, or by locating the coordinates by using an existing service that returns the coordinates for an entered address, city, state, or a zip code. At 930, users may search an existing database of locations and select one to specify a user location. The example in screen shot 900 shows a search for the category “city”, whereby cities are shown in accordance with the state the city is in, the country, and coordinates. Other embodiments may display different related information and also may provide searching by other categories.

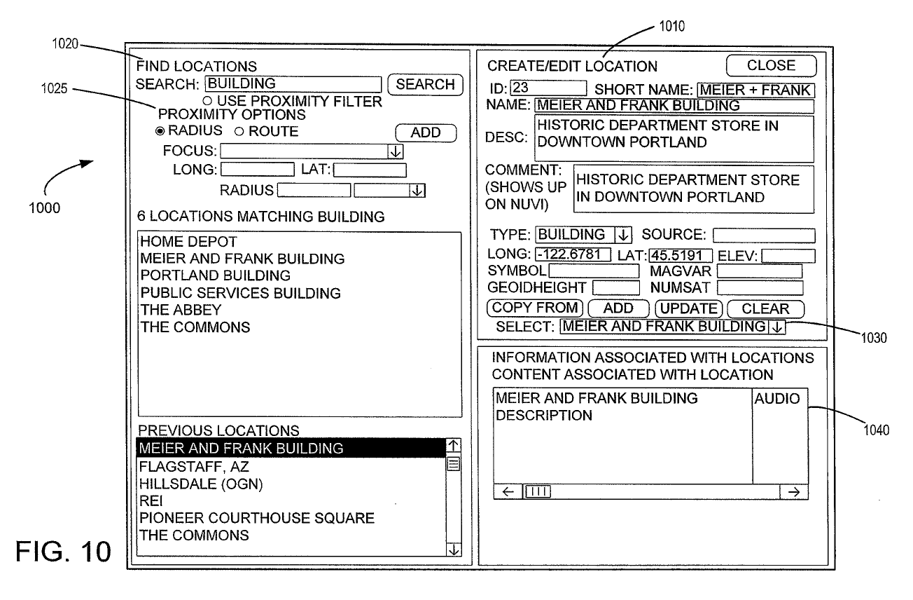

FIG. 10 illustrates a screen shot 1000 depicting a page for managing locations for content according to the present disclosure. A location may be created or edited at 1010, wherein locations may be specified by name, any descriptive information, geographic coordinates, a location type (such as building, natural feature, river, city, etc.), by optional GPS relevant information, etc. Then, at 1020, locations may be searched by name and further filtered by specified proximity 1025. As an example, the specified proximity 1025 allows searching of locations matching “city hall” within a 100 mile radius of a focus location. Additionally, screen shot 1000 illustrates functionality at 1030, whereby location details can be copied from existing locations and edited. In this way, locations may be associated with one or more content items which are then managed through the content management page 710 described above in reference to FIG. 7.

FIG. 11 illustrates a hierarchy of interests 1100, also called a taxonomy of interests, for providing location based information related to user preferences according to embodiments of the present disclosure. FIG. 11, in part, shows a category of movies 1110, which may comprise one or more types of movies, such as comedy 1112 movies. Movies 1110 may also be related to foreign language films 1120, although the relationship between movies 1110 and foreign language films 1120 may be a parent-child relationship as opposed to a type relationship as illustrated with comedy 1112. Foreign language films 1120 may be a parent to Italian language films 1122, and foreign language films 1120 may also be related to a foreign language 1130. Additionally, the taxonomy of interests may index content with non-hierarchical relationships, for example, between Italy 1150 and Italian Opera 1148. Other categories and relationships are illustrated by way of example in FIG. 11.

The hierarchy of interests 1100, may be used to index user preferences, for example the user preferences 117 in FIG. 1, and the hierarchy of interests may also be used to index available information that may be matched to user preferences. In this manner, a system, method, or apparatus may provide location based information based on user preferences.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description. The subject matter of the present disclosure includes all novel and nonobvious combinations and subcombinations of the various processes, systems and configurations, and other features, functions, acts, and/or properties disclosed herein, as well as any and all equivalents thereof.

1. A method of determining location based information related to preferences, the method comprising:
storing a first data set of geographic locations in a memory;
storing a second data set in the memory, wherein the second data set includes information related to at least one of the geographic locations, and the information is hierarchically organized by content according to an indexing scheme;
specifying a set of user preferences, wherein the set of user preferences is hierarchically organized by content according to the indexing scheme; and
generating a set of interests for a specific geographic location, wherein the set of interests includes at least one of:
information common to the set of user preferences and the second data set; and
information in the second data set related to information in the set of user preferences by the indexing scheme.

2. The method of claim 1, wherein the specific geographic location is determined using a Global Positioning System receiver.

3. The method of claim 1, further comprising providing the set of interests for the specific geographic location through a user interface.

4. The method of claim 3, wherein the user interface is a graphical user interface, an audio user interface.

5. The method of claim 4, wherein the graphical user interface is a website.

6. The method of claim 1, further comprising:
storing the set of interests for the specific geographic location in a file; and
downloading the file to a mobile device.

7. The method of claim 6, wherein the mobile device is a personal travel assistant.

8. The method of claim 1, wherein the second data set further includes time-based information related to at least one of the geographic locations.

9. A computer-readable medium comprising instructions executable by a computing device to provide location based information related to user preferences, the instructions being executable to perform a method comprising:
storing a first data set in a memory, wherein the first data set includes information related to at least one geographic location, and the information is hierarchically organized by content according to an indexing scheme;
specifying a second data set that includes user preferences, wherein the user preferences are hierarchically organized by content according to the indexing scheme;
determining a specific geographic location using a Global Positioning System receiver; and
generating a data set of interests for the specific geographic location, wherein the data set of interests comprises at least one of:
information common to the first data set and the second data set, and
information in the first data set related to information in the second data set by the indexing scheme.

10. The computer-readable medium of claim 9, further comprising instructions for providing the data set of interests for the geographic location through a user interface.

11. The computer-readable medium of claim 10, wherein the user interface is a graphical user interface or an audio user interface.

12. The computer-readable medium of claim 11, wherein the graphical user interface is a website.

13. The computer-readable medium of claim 9, further comprising instructions for:
storing the data set of interests for the specific geographic location in a file; and
downloading the file to a mobile device.

14. The computer-readable medium of claim 9, wherein the first data set further includes time-based information related to at least one of the geographic locations.

15. The computer-readable medium of claim 9, wherein the first data set is stored in a first database and the second data set is stored in a second database.

16. An apparatus comprising:
an input;
a memory to store a first data set that includes information related to at least one geographic location, and the memory further to store a second data set that includes user preferences, wherein the information and the user preferences are hierarchically organized by content according to an indexing scheme;
a Global Positioning System receiver to determine a specific geographic location;
a processor coupled with the input, the memory and the Global Positioning System receiver, the processor to generate a data set of interests for the specific geographic location, wherein the data set of interests comprises at least one of:
information common to the first data set and the second data set, and
information in the first data set related to information in the second data set by the indexing scheme.

17. The apparatus of claim 16, further comprising an output coupled with the processor, the output to provide the data set of interests for the geographic location to a user interface.

18. The apparatus of claim 17, wherein the user interface is a graphical user interface or an audio user interface.

19. The apparatus of claim 18, wherein the graphical user interface is a website.

20. The apparatus of claim 16, wherein the first data set further includes time-based information related to at least one of the geographic locations.
